(19) United States
(12) Patent Application Publication
(10) Pub. No.: US 2012/0117455 A1
(43) Pub. Date: May 10, 2012

(54) ANTHROPOMIMETIC ANALYSIS ENGINE FOR ANALYZING ONLINE FORMS TO DETERMINE USER VIEW-BASED WEB PAGE SEMANTICS

(75) Inventors: Alexis Fogel, Paris (FR); Guillaume Maron, Paris (FR); Jean Guillou, Paris (FR)

(73) Assignee: Kwift SAS (a French corporation), Puteaux (FR)

(21) Appl. No.: 13/113,992

(22) Filed: May 23, 2011

(30) Foreign Application Priority Data
Nov. 8, 2010 (FR) 10/04360
Nov. 8, 2010 (FR) 10/04361

(51) Int. Cl. G06F 17/00

(52) U.S. Cl. 715/221; 715/234

(57) ABSTRACT

An analysis engine executes under client control to review web pages in real-time and control interaction with the web pages of a website to assist the user of the client in providing selections, providing information and otherwise interacting with the website. In analyzing web pages, the engine uses rule-based logic and considers web pages from an anthropomimetic view, i.e., considers the content, forms and interaction elements as would be perceived and dealt with by a human user, as opposed to by merely considering the web pages in their native form, such as HTML formatted files.

### CROSS-REFERENCE TO RELATED APPLICATIONS

This application is a Nonprovisional patent application claiming benefit under 35 USC §119(a) of the following applications, each naming Guillaume Maron, Jean Guillou, and Alexis Fogel:

French patent application Ser. No. 10/04360, filed Nov. 8, 2010, with the title “Méthode et systeme d'execution informatisée de tâches sur Internet”, and

French patent application Ser. No. 10/04361, filed on Nov. 8, 2010, with the title “Procédéet système informatisée d'achat sur le web”.

Each application cited above is hereby incorporated by reference for all purposes. The present disclosure also incorporates by reference, as is set forth in full in this document, for all purposes, the following commonly assigned applications/patents:

U.S. patent application Ser. No. ______ [Attorney Docket No. 93180-800064] filed of even date herewith and entitled “METHOD AND COMPUTER SYSTEM FOR PURCHASE ON THE WEB” naming Fogel, et al. (hereinafter “Fogel I”);

U.S. patent application Ser. No. ______ [Attorney Docket No. 93180-800065] filed of even date herewith and entitled “TASK AUTOMATION FOR UNFORMATTED TASKS DETERMINED BY USER INTERFACE PRESENTATION FORMATS” naming Fogel, et al. (hereinafter “Fogel II”); and

U.S. patent application Ser. No. ______ [Attorney Docket No. 93180-800067] filed of even date herewith and entitled “METHOD AND SYSTEM FOR EXTRACTION AND ACCUMULATION OF SHOPPING DATA” naming Guillaume, et al. (hereinafter “Guillaume I”).

### FIELD OF THE INVENTION

The present invention relates generally to automation of interactions with web pages and more specifically to determining semantics of web pages, its associated elements, and forms based on human user views of the web pages.

### BACKGROUND

Due to the growth, popularity and usefulness of the Internet, a great many transactions are now undertaken using the Internet, typically in the form of user manual interactions with web pages. In a typical operation, a user's browser makes a request to a web server, the web server returns the requested page, wherein the requested page includes form fields, buttons, images and/or other user input elements. When the user's browser receives the requested web page, typically in the form of data encoded using the HTML protocol, the browser considers user preferences and device capabilities, and renders the requested page, presents a view of that page to the user in a browser window and waits for the user to input data into the form fields or otherwise interact with the web page elements.

These methods can be used for online transactions, shopping, browsing, reserving, logging in, creating an account, and many other online tasks or user actions. For example, the user might visit a website (i.e., cause his or her browser to retrieve a webpage that is part of a collection of static or dynamic web pages collectively referred to, possibly along with associated data structures, a “website”), view products for sale, indicate selections, provide purchase instructions and details, etc. by interacting with web page elements.

Another approach for online user interactions is to provide a computer-to-computer interface, such as an application program interface, or “API”, that would allow one computer or computer process to programmatically provide specifications and details of a requested user transaction. More typically, vendors only provide a web interface with pages designed for human user interaction.

The web interfaces that are designed for human interaction are often intuitive and trivial for a human to understand what is expected. For example, there might be text stating “Please select one or more products” and form field with a nearby label with the text “Address” and so forth. However, it can be quite difficult to automate this process because there is an expectation that the interaction will be entirely driven by a human.

Many features of human interfaced web pages are problematic for computer automation. For example, a computer process might be put in place that is preconfigured to insert data and extract data from web pages based on the layout, format and testing of a particular entity's website. This can work well if there is a close association between the operators of that website and the programmers configuring the computer process. Unfortunately, that is rarely the case and even if programmers would program the computer process manually based on reviewing a website, the website could change at any time and possibly break the programmer's assumptions.

In fact, sometimes even when it is in a vendor's interest to have user interactions with its website go quickly and smoothly, the vendor is not able to provide that functionality. Many times, a user might tire of having to reenter user information repeatedly, sign up for access, etc. and therefore sales can be lost. As one example, users may have to maintain multiple logins and authentication credentials for a plethora of sites. Web sites individually operated by distinct business entities will generally not coordinate or share information, so users are forced to enter often laborious and tedious information, such as address and phone numbers, repeatedly. Such demands lead to user dissatisfaction, resulting in reduced sales, compromised security, and overall degradation in quality of user experience.

Some websites have resolved some of these problems by providing assistance to their users by saving their data and pre-filling its form fields with known data. However, such a solution is site-specific and does not address information sharing across a multitude of websites (e.g., it still requires a user to enter consumer information at least once per website).

What is needed is a way to automate user interactions with web pages in real-time without having to rely on advance knowledge of the structure, layout or content of websites, and associated web pages.

### BRIEF SUMMARY

In some embodiments of an analysis engine according to the present invention, the web page analysis engine executes under client control to review web pages in real-time and control interaction with the web pages of a website to assist the user of the client in providing selections, providing information and otherwise interacting with the website. In analyzing web pages, the engine uses rule-based logic and considers web pages from an anthropomimetic view, i.e., considers the content, forms and interaction elements as would be perceived and dealt with by a human user, as opposed to by merely considering the web pages in their native form, such as HTML formatted files.

In a specific embodiment, a web page is analyzed as it would appear to a user. For example, hidden text and code comments that a user does not see might not be taken into account, but where two page elements that are far apart in the web page file but appear near each other from the user's view are treated as being nearby elements. In another example, three input text fields preceded with a “phone” nomenclature for visible text and vertically aligned with each other, may lead to the deduction that the three fields are parts of a phone number, the area code, prefix and suffix.

In another embodiment, the web page analyzer will also function to extract user-supplied data to be stored on behalf of the user. For example, if a user supplies the address, phone, and shipping information on a page, this information along with its context (e.g., the understanding of what each field of the supplied information represents to a human being) will be stored in a database. For example, the supplied city for a home address will be stored as the city for the home address. In one embodiment, the consumer information database is local to a client machine while in others it may also reside on servers on the larger network or the cloud.

In yet another embodiment, the web page analyzer will function to pre-populate the analyzed webpage. The user-supplied information that is stored in a local database can be used for this purpose. In one aspect, the consumer information database may be populated with a client application installed on the client machine. In another aspect, the consumer information database will be populated by previously analyzed pages of the webpage analyzer component. In either case, once the meaning of the user interaction elements is determined by the web page analyzer, it is possible to populate the fields with any available consumer information.

In one embodiment, a rules tool is supplied for the user to enter user perception, context-based and other rules for the webpage analyzer engine to apply. The tool advantageously allows the testing of a user entered rule in real-time on a multitude of merchant websites. This can be done efficiently by the previous storing of web pages that were navigated by users, and applying the newly entered or modified rule to the stored pages to determine the validity of the rule. This real-time rule validation capability can also allow the user to interactively modify a rule that leads to breaking of the semantic understanding of a page element. Advantageously the rules analysis can be shared with other users of the system. In some aspects, the user in this scenario will be the administrator of the web page semantics analyzer system.

In one embodiment, a computer-implemented method is provided for determining webpage semantic structure. It comprises of the steps: detecting user interaction with a user-navigated webpage, analyzing the user-navigated webpage using user-perception techniques, and determining semantic structure of the user-navigated webpage based on the analysis, wherein the semantic structure provides information about the function of an element of the webpage, or forms on the webpage, or other information about the user-navigated webpage.

In another embodiment, a method is provided for analyzing a plurality of vendor web-based customer interfaces, wherein a web-based customer interface of a vendor comprises software and/or data, that when used with a browser or other client-side software, presents the web-based customer interface to a user. The method comprises of the following steps: analyzing a user-navigated web page of a target vendor web-based customer interface being analyzed, wherein the user-navigated web page contains interface elements designed for human interaction; monitoring user inputs from a human user of the user-navigated web page's interface elements; extracting user-supplied customer information from the user-navigated web page's interface; matching the user-supplied customer information to context information about the user-navigated web page using results of the analyzing; and storing the user-supplied customer information and corresponding context information with reference to the user-navigated web page and/or the target vendor web-based customer interface being analyzed, thereby allowing for the user-supplied customer information in different contexts for different vendor web-based customer interfaces.

The following detailed description together with the accompanying drawings will provide a better understanding of the nature and advantages of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 is a simplified block diagram of one embodiment of a networked, Internet client server system.

FIG. 2 is a simplified block diagram of one embodiment of an Internet client machine, running components of the system described herein.

FIG. 3 is a simplified block diagram of one embodiment of a Webpage Semantics Analyzer, installed and running on a client machine.

FIG. 4 is a flow diagram illustrating steps performed in a Webpage semantics analysis procedure to determine the semantics of a user-navigated webpage, the extraction of user-supplied information during that analysis, and the pre-populating of user interaction elements before modifying the webpage.

FIG. 5 provides two form signatures for the Webpage analyzer system to use in determining web page form meaning.

FIG. 6 illustrates the results of rules analysis.

FIG. 7 illustrates the results of a form type analysis.

### DETAILED DESCRIPTION

As explained herein, methods and apparatus can be provided that analyze web pages from a human view in order to automate interactions with those pages. As part of a web page analyzer, it might derive semantic understanding of user-navigated web pages to enhance user experience by providing assistance in their interaction with web pages. While the web pages might be provided over one or more different types of networks, such as the Internet, and might be used in many different scenarios, many of the examples herein will be explained with reference to a specific use, that of a user interacting with web pages from an e-commerce web sites, with user interactions including authentication (e.g., logging in), purchase selection, provision of purchase and/or user information (e.g., name, address, credit card number), confirmation of purchase details (e.g., totals, shipping, etc.) as well as storing such pages, and doing so in an automated manner where appropriate.

Those skilled in the art will appreciate that web page analysis to derive semantic understanding of its contents has many applications and that improvements inspired by one application have broad utility in diverse applications that employ semantic analysis of web pages.

Below, example hardware is described that might be used to implement aspects of the present invention, followed by a description of software elements.

### Network Client Server Overview

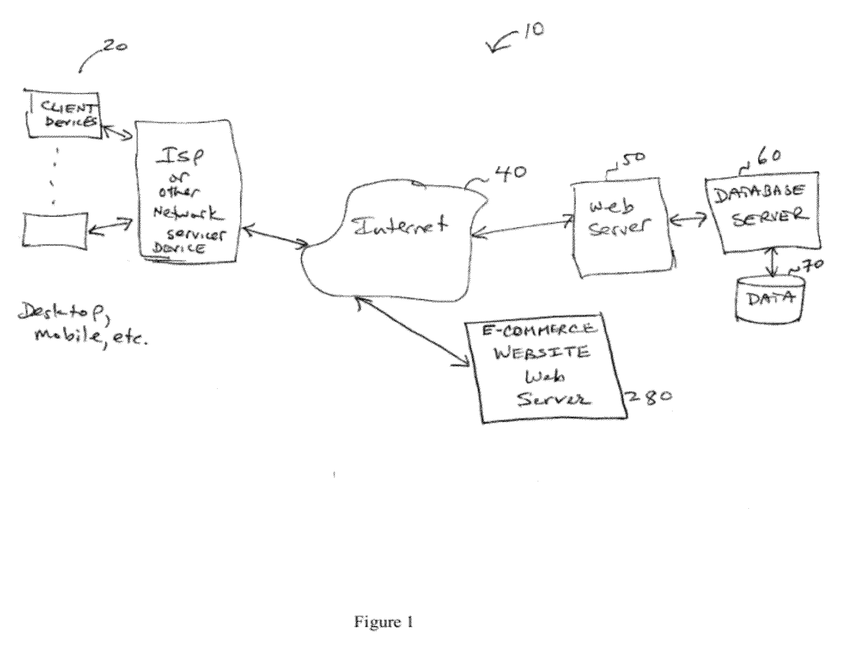

FIG. 1 is a simplified functional block diagram of an embodiment of an interaction system 10 in which embodiments of the web page analyzer system described herein may be implemented. Interaction system 10 is shown and described in the context of web-based applications configured on client and server apparatus coupled to a network (in this example, the Internet 40). However, the system described here is used only as an example of one such system into which embodiments disclosed herein may be implemented. The various web page analyzer components described herein can also be implemented in other systems.

Interaction system 10 may include one or more clients 20. For example, a desktop web browser client 20 may be coupled to Internet 40 via a network gateway. In one embodiment, the network gateway can be provided by Internet service provider (ISP) hardware 80 coupled to Internet 40. In one embodiment, the network protocol used by clients is a TCP/IP based protocol, such as HTTP. These clients can then communicate with web servers and other destination devices coupled to Internet 40.

An e-commerce web server 80, hosting an e-commerce website, can also be coupled to Internet 40. E-commerce web server 80 is often connected to the internet via an ISP. Client 20 can communicate with e-commerce web server 80 via its connectivity to Internet 40. E-commerce web server 80 can be one or more computer servers, load-balanced to provide scalability and fail-over capabilities to clients accessing it.

A web server 50 can also be coupled to Internet 40. Web server 50 is often connected to the internet via an ISP. Client 20 can communicate with web server 50 via its connectivity to Internet 40. Web server 50 can be configured to provide a network interface to program logic and information accessible via a database server 60. Web server 50 can be one or more computer servers, load-balanced to provide scalability and fail-over capabilities to clients accessing it.

In one embodiment, web server 50 houses parts of the program logic that implements the web analyzer system described herein. For example, it might allow for downloading of software components, e.g., client-side plug-ins and other applications required for the systems described herein, and synching data between the clients running such a system and associated server components.

Web server 50 in turn can communicate with database server 60 that can be configured to access data 70. Database server 60 and data 70 can also comprise a set of servers, load-balanced to meet scalability and fail-over requirements of systems they provide data to. They may reside on web server 50 or on physically separate servers. Database server 60 can be configured to facilitate the retrieval of data 70. For example, database server 60 can retrieve data for the web analyzer system described herein and forward it to clients communicating with web server 50. Alternatively, it may retrieve transactional data for the associated merchant websites hosted by web server 50 and forward those transactions to the requesting clients.

One of the clients 20 can include a desktop personal computer, workstation, laptop, personal digital assistant (PDA), cell phone, or any WAP-enabled device or any other computing device capable of interfacing directly or indirectly to Internet 40. Web client 20 might typically run a network interface application, which can be, for example, a browsing program such as Microsoft's Internet Explorer™, Netscape Navigator™ browser, Google Chrome™ browser, Mozilla's Firefox™ browser, Opera's browser, or a WAP-enabled browser executing on a cell phone, PDA, other wireless device, or the like. The network interface application can allow a user of web client 20 to access, process and view information and documents available to it from servers in the system, such as web server 50.

Web client 20 also typically includes one or more user interface devices, such as a keyboard, a mouse, touch screen, pen or the like, for interacting with a graphical user interface (GUI) provided by the browser on a display (e.g., monitor screen, LCD display, etc.), in conjunction with pages, forms and other information provided by servers. Although the system is described in conjunction with the Internet, it should be understood that other networks can be used instead of or in addition to the Internet, such as an intranet, an extranet, a virtual private network (VPN), a non-TCP/IP based network, any LAN or WAN or the like.

According to one embodiment, web client 20 and all of its components are operator configurable using an application including computer code run using a central processing unit such as an Intel Pentium™ processor, an AMD Athlon™ processor, or the like or multiple processors. Computer code for operating and configuring client system 20 to communicate, process and display data and media content as described herein is preferably downloaded and stored on a processor readable storage medium, such as a hard disk, but the entire program code, or portions thereof, may also be stored in any other volatile or non-volatile memory medium or device as is well known, such as a ROM or RAM, or provided on any media capable of storing program code, such as a compact disk (CD) medium, a digital versatile disk (DVD) medium, a floppy disk, and the like. Additionally, the entire program code, or portions thereof, may be transmitted and downloaded from a software source, e.g., from one of the servers over the Internet, or transmitted over any other network connection (e.g., extranet, VPN, LAN, or other conventional networks) using any communication medium and protocols (e.g., TCP/IP, HTTP, HTTPS, FTP, Ethernet, or other media and protocols).

It should be appreciated that computer code for implementing aspects of the present disclosure can be C, C++, HTML, XML, Java, JavaScript, etc. code, or any other suitable scripting language (e.g., VBScript), or any other suitable programming language that can be executed on a client or server or compiled to execute on a client or server.

### Anthropomimetic System Overview

In certain embodiments, methods and systems are provided to ease user interactions with a host of websites. For example, upon navigation to a web page, known user data can be used to automatically populate fields of the web page on behalf of the user, thereby avoiding the need for a user to enter redundant data across a multitude of websites. As another example, actions often repeated across a multitude of websites can be taken automatically on behalf of the user (e.g., automatically login to a website, or automatically provide account and shipping details during an online shopping purchase) where a user has provided a preference for automation of that task.

In certain aspects, user interactions with web pages of merchant websites are simplified by advantageously providing methods and systems that determine webpage semantics, independent of any particular website. Such site-independent implementation eases user interactions across the Web overall, thereby precluding the need for each individual vendor website to implement its own logic to assist users. For example, once a user provides customer information (e.g., name, address, phone number), that information can then be stored and used on another vendor's website by pre-populating that vendor's form with the known user data. As another example, once a form type is determined, such as a login form, then a user preference based automation of logging in is made possible. Both, the pre-population of user interactive elements and automation of a user macro-action in a site-independent fashion, are made possible by the semantic analysis of the webpage.

In some aspects, the site-independent analysis of semantic structure of web pages leads to an understanding of the meaning of webpage elements and/or form types of websites. A form can be an HTML form but is not limited to an HTML form. More generally a form is any group of elements that a user interacts with on a webpage, comprising of a logical function (e.g., login, billing information, shipping information, purchase confirmation page, and account creation form). The semantic analysis of an element may show that it is a mobile phone number or land-line number. It may also help determine that a page allows for a user to take for example a login action or submit ‘shipping address information’ action, etc.

The deciphered semantic webpage structure can then be used to make a host of decisions on behalf of the user, thereby un-complicating a user's web experience. For example, once the semantic structure of a webpage being analyzed is understood, the page can be modified by populating form fields with known user information (e.g., from a consumer information database) on behalf of the user. Furthermore, where the user has so chosen, the actual task on that page can be automated and executed for the user. For example, once the semantic analysis leads to the understanding that the user is navigating on the login page of a website, the user can be logged on automatically. The automation can be achieved by pre-populating the login and password fields and executing the “submit” button.

In some aspects, the above improvements are made possible by employing anthropomimetic analysis of user pages. Such an analysis allows for page elements and actions to be understood from a human view perspective, i.e., by considering the content, forms and interaction elements as would be perceived and dealt with by a human user, as opposed to by merely considering the web pages in their native form, such as HTML formatted files.

### Webpage Semantic Analyzer System Components

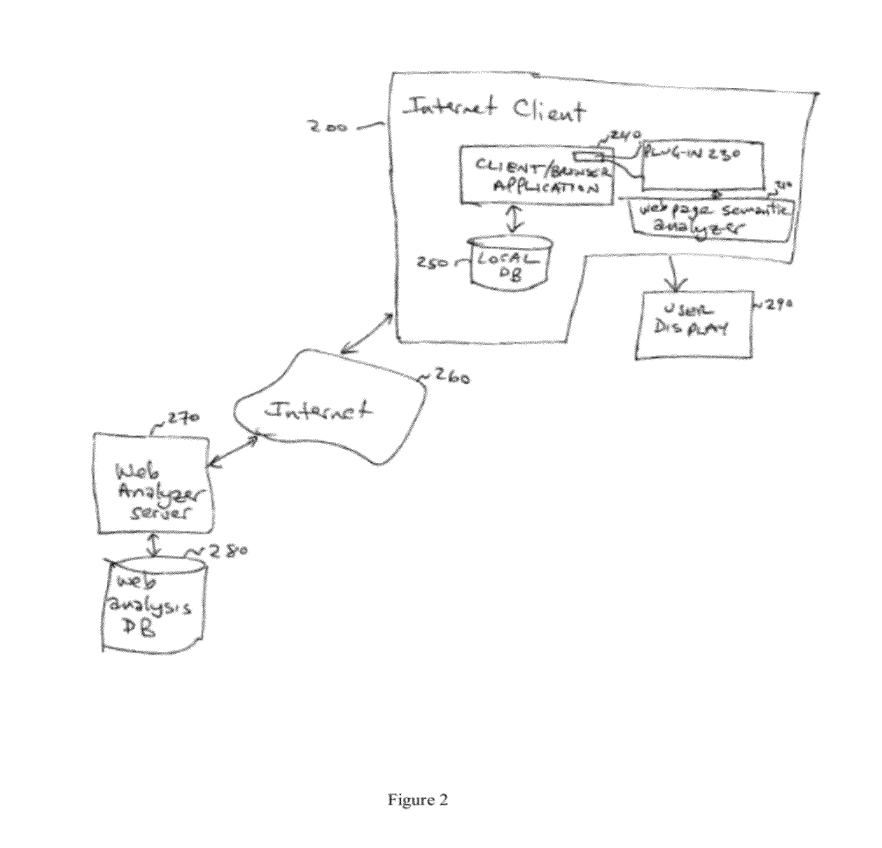

FIG. 2 is a simplified functional block diagram of an embodiment of a desktop client 200 in which embodiments of the web page semantics analyzer system described herein may be implemented. Client 200 is one example of a client in the Internet system described in FIG. 1. It is coupled with the internet 260 to communicate with Web Analyzer server 270, which in turn is connected to the Web Analyzer database 280.

For example a Client application 240 is downloaded and installed on a Client machine 200. The application 240 allows for a user to enter consumer information that may be used for pre-populating fields by the Webpage analyzer 210 to modify the webpage with such user-supplied data. As one illustration, once the meaning of elements of a webpage is understood, the corresponding information can be filled in for the user interaction element on behalf of the user. It also allows the user to specify preferences such as to automate login for a particular website, or to provide assisted purchasing options for another website. Application 240 may in turn store some or all of the user entered data into a local database 250. Alternatively, it may transmit some of the information to the Web Analyzer server 270 to store on a Web Analyzer database 280.

Client 200 also runs a Web browser 220 which has installed and embedded in it a Web Analyzer plug-in 230. The Client also has a Web Page analyzer component 210 and a Client application 240. The Client application 240 can be coupled to a local database 250. In one aspect, these components of Client 200 can be downloaded from the Web Analyzer server 270 via the internet 260.

In one embodiment, plug-in 230 is a thin application that serves the function of taking information about a user-navigated web page and passing it on to the Web Page analyzer component 210. In one embodiment, plug-in 230 is programmed in JavaScript and C++. It retrieves information about the user-navigated webpage, such as partial document object model (DOM) of the page, context information (e.g., context of the elements such as surrounding text or tooltips, etc.), and other page information, to pass on to the analyzer component 210. The analyzer component 210 then parses the DOM elements of the webpage and applies logic to determine semantics of the user-navigated webpage in order to understand the meaning of its elements and form type as a human user would.

### Webpage Semantics Analyzer Details

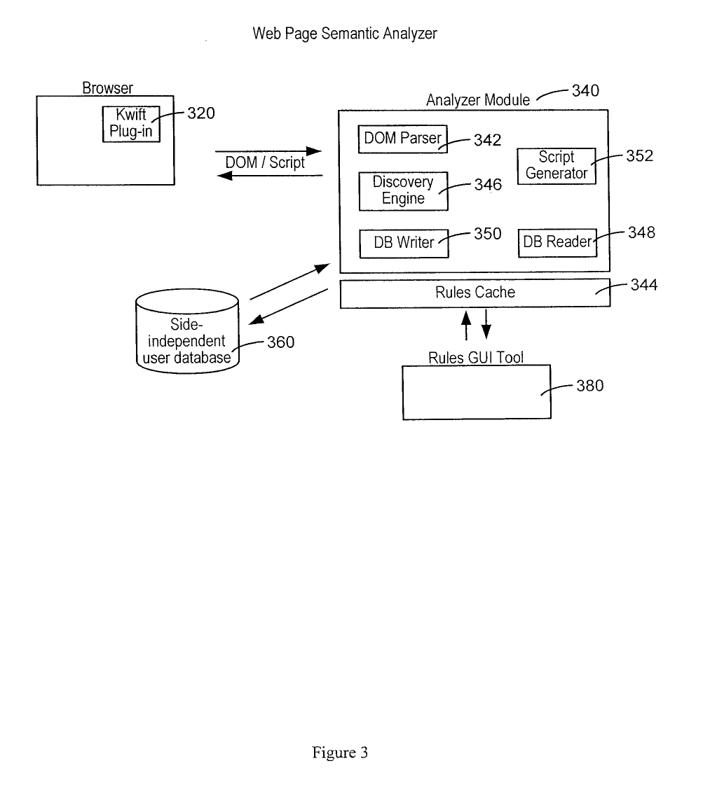

FIG. 3 is a functional block diagram of a detailed embodiment of a webpage semantics analyzer system. Upon the browsing of a webpage in a browser 300, plug-in 320 intercepts the webpage. Plug-in 320 then creates at least a partial Document Object Model (DOM) of the webpage, extracts other information about the webpage, and sends it to webpage semantics analyzer 340. The analyzer's parser component 342 then extracts elements of the webpage from the supplied DOM of a webpage to be analyzed. A discovery engine 346 then applies user-perception and context-based logic to determine meaning of a webpage's elements and associated forms, thereby determining its semantic structure. For example, the analysis may include looking at the values in the attributes of an element, surrounding text or alignment of an element, relationship between elements, and/or the values of the tooltips associated with elements to determine its meaning or use.

The webpage semantics analyzer 340 also has components 348 and 350. During the discovery engine's analysis, where user data is supplied in a user interaction element, such data can be extracted and written by component 350 to a user database 360. And component 348 can retrieve data, once the discovery engine has determined meaning of an element, to pre-populate a field on behalf of the user. Finally, a script generator 352 creates the page to be returned to browser 300.

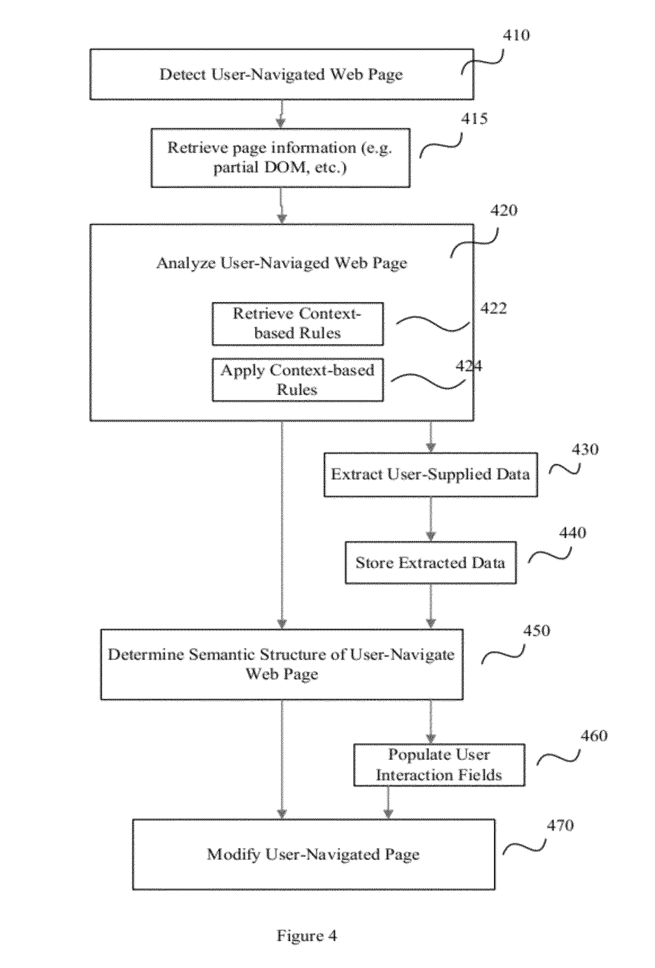

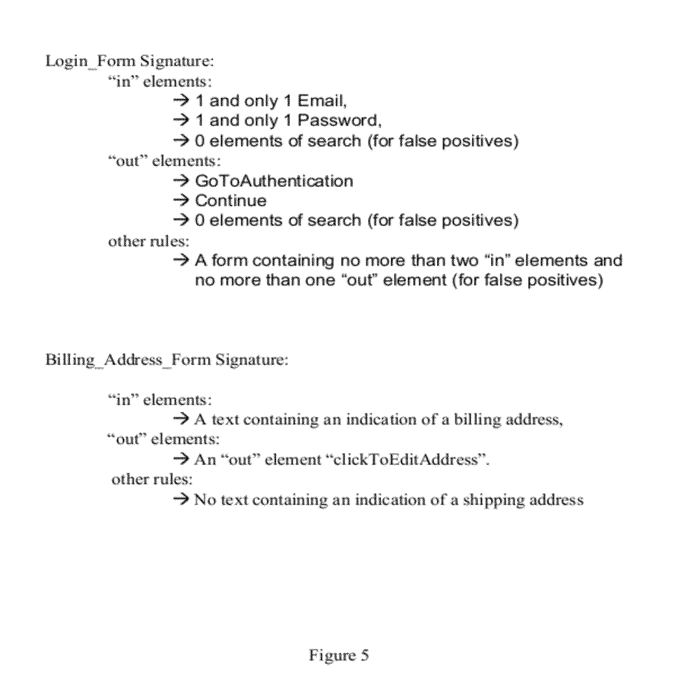

In one embodiment, semantic structure is determined in real-time upon the detecting of a user's navigation to a webpage. The navigated page is then analyzed to determine its meaning and semantic structure. FIG. 4 illustrates the steps taken in this process. At step 410 the plug-in detects a user-navigated webpage. Step 415 retrieves certain information about that page and that page is analyzed at step 420. In some aspects, all elements of a page are first extracted then a semantics engine will analyze all elements to decipher their meaning. In one embodiment, this is done by a webpage analyzer component installed on the client machine. And at step 450 the analysis leads to the determination of the semantic structure of the user-navigated webpage. The analyzed web-page can then be modified, in step 470, as displayed to the user.

For example, a user may navigate to a login webpage for a merchant's website. The plug-in would then retrieve information about the login page (e.g., the partial DOM, etc.) and send it over to the webpage analyzer component for determining the meaning of elements on the login page and of the form type. An analysis of the page may lead to the understanding that the page contains two input elements a login text field and below it a password text field. Using the elements and form signatures the engine may also be able to determine that there is a login form present on the page. Thus, the semantic structure of this example may show that the page contains a login form type and that there are two user interaction elements, the login text field and a password text field, and one user action “authenticate” available on the form.

A login form can also be on the footer or on the header of a page. However, in one embodiment, elements and forms that are present on the header or on the footer are categorized as irrelevant for purposes of the analysis. In some cases, since they are present on all pages of the website, they do not provide context specific information for a particular web page being analyzed. Therefore, actions on forms present on the header and footer would not be executed, as part of for example, automation of a purchasing procedure.

The form type may also indicate the possible actions for a form. For example, a login form type may mean there is one possible macro-actions “login”. Based on this understanding, the fields can be pre-populated and the user can be automatically logged in if so chosen by the user. Another purchasing form type may indicate two possible actions such as “register/create new account” or “checkout as a guest”. It is possible to have more than one form type on a page and to have a form with more than one action.

As another example, a user may navigate to a “create new account type of page”. The user interaction elements may be identified by a set of rules as for example, first name, last name, email address, password, etc. After which and by comparing with form signatures the resulting semantic understanding may determine that the page has a registration form with the described elements, and actions associated with that form type.

### Discovery Engine—Rule-Based Analysis

In one embodiment the webpage semantics analysis is done using user-perception and/or context-based techniques. User-perception techniques analyze elements using anthropomimetic techniques, for example, the way a user sees them on a page. For example, when a human user observes two input fields next to each other, one named login and the other named password, she is able to assemble its meaning as a login form, available to the user to logon to the website/resource. In some cases, the analysis may include looking at the values in the attributes of an element, surrounding text or alignment of an element, relationship between elements, and/or the values of the tooltips associated with elements to determine its meaning or use.

In one embodiment, such user-perception and/or context-based techniques employ a rules-based discovery engine 346 of FIG. 3. The engine 346 retrieves rules from a rules cache 344 and applies them to the extracted elements to determine their meaning or semantic structure. As illustrated in FIG. 4, in one embodiment the steps for rule application are performed during the analysis step 420 of the webpage semantics analysis. Step 422 retrieves the rules and step 424 applies the rules to the elements of the webpage being analyzed.

In some embodiments, context-based rules provide the relationship of one element to another element to extract meaning. For example, one of the context-based rules may state that when three text input fields align vertically with each other and are preceded with a string containing “mobile” and “phone” or “number”, then the elements represents the user's mobile phone number in three parts. As another example, a rule may indicate that when a password field is preceded by a login field then it is a login form.

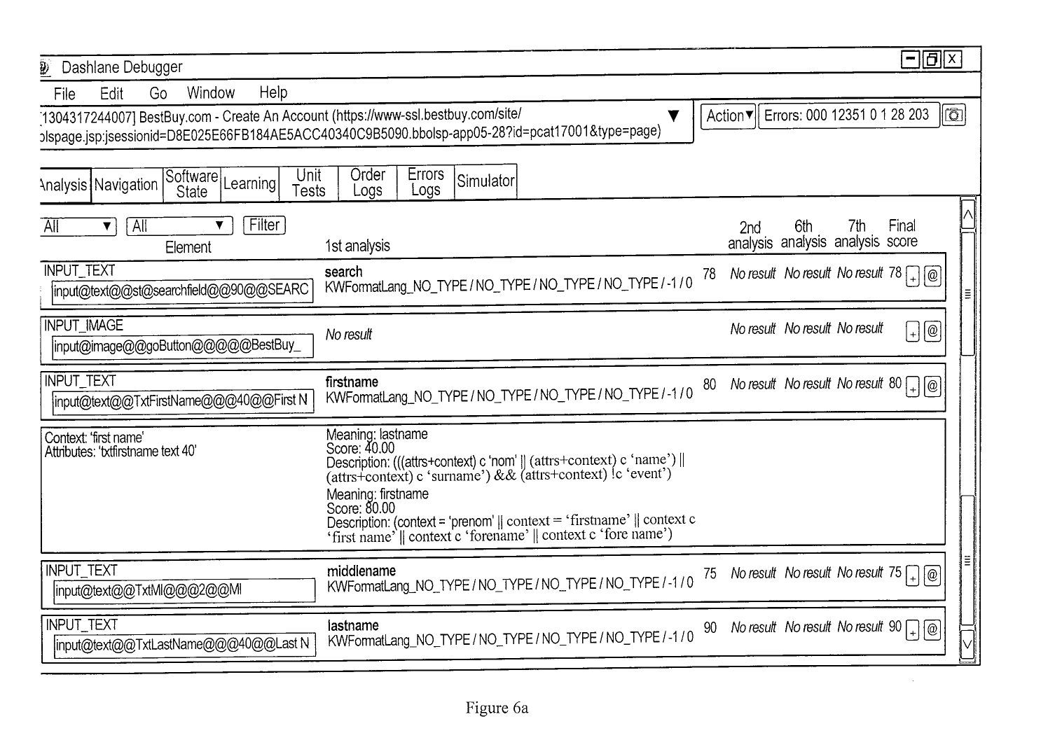

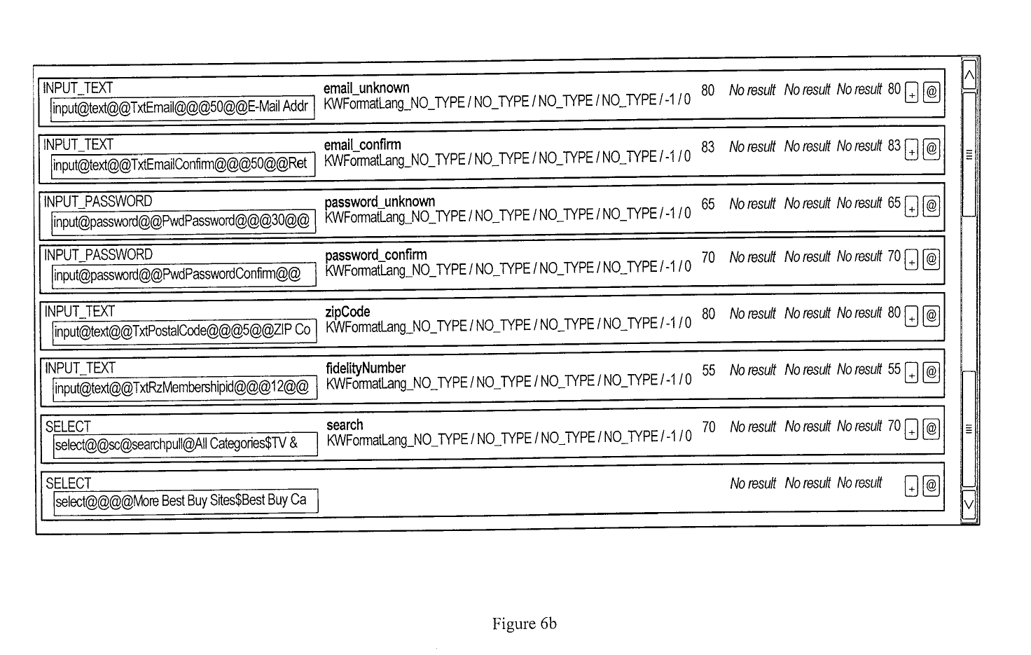

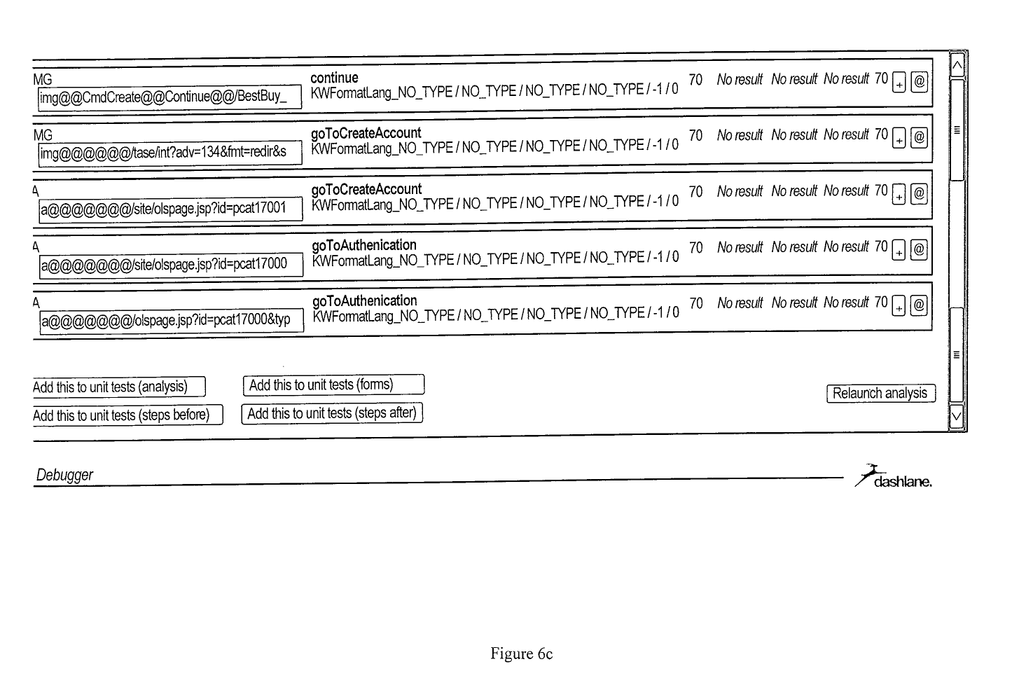

In one embodiment, the discovery engine applies rules using several layers, where one layer handles some basic interpretation, the next layer refines the interpretation for more complicated instances, etc. For example, a three-layer rule set might be used, wherein the first layer is an “atomic layer” wherein there is an atomic, “per element” rule set used for analysis, then a “domain layer” wherein the rules are domain-specific rules, and then a “context layer” wherein the rules are context-based rules. In another embodiment, the engine also employs form identification in addition to the rules sets. In one embodiment, the sequence followed in the analysis of elements of a page is atomic layer analysis, followed by domain layer analysis, followed by form identification, and finishing with the context layer analysis. In one embodiment, the context layer analysis incorporates information from the form identification step in determining further meaning of an element. FIG. 6 shows the results of running rules on elements of a webpage.

In some aspects, rules have associated with them scores. The scores are used to determine which rules to apply to an element being examined. For example, once a rule is applied to an element and is found to be compliant to the rule (i.e., the rule is a “hit”), then the element has at least that score associated to it. In one embodiment, only rules with a possible score higher than the associated “hit” score will be subsequently applied to an element being analyzed. Such rule filtering based on scores can advantageously improve performance of the discovery engine.

In one embodiment, the context layer analysis is always performed for a rule being analyzed. In that embodiment, the context layer analysis does not help determine the meaning of an element, rather it only adds precision to the meaning of the element. For example, if the atomic layer analysis finds three phone number fields with a high score, then the context layer analysis might help determine that they are phonenumber_part1, phonenumber_part2, and phonenumber_part3.

In some aspects, information is maintained about an element beyond just its meaning. For example, the system may keep track of elements that are present on every page of a website (e.g., elements in the header or footer of a website). Such information may then be used to flag fields as being irrelevant for the element/page analysis and for purposes of navigation or automatic execution. For example, for purchasing automation on a merchant website as described in Fogel I, these fields and/or forms may be ignored or not executed on behalf of the user for automating the user's purchase.

Following are three examples of rules as applied to elements on a page.

### Example 1

For any element IF (this element is an input type) AND (its context is “first name”) THEN (the meaning of this element is “first name”)

### Example 2

For any element IF (this element is an input type) AND (its meaning is “complementForAddress”) AND (the smallest form containing this element is an address form, whether for shipping/billing or other purposes) AND (the smallest form containing this element does not contain any element with a meaning “addressline1”) AND (the smallest form containing this element does not contain any element with a meaning “streetname”) AND (the smallest form containing this element does not contain any element with a meaning “streetnumber”) THEN (the meaning of this element is “addressline1”).

### Example 3

For any element IF (this element is a select type) AND (its meaning is “yearCreditCard”) AND (the next element's meaning is “yearCreditCard”) THEN (the meaning of this element is “monthCreditCard”).

A rule for “lastname” may also apply for Example 1, but its score will be inferior. As for Example 2, if there is registration form containing an address form, and if an element is in the address form then “the smallest form” containing the element is the address form and “the biggest form” is the registration form.

### Discovery Engine—Forms Analysis (Form Type and Associated Macro-Actions)

In other embodiments, semantics structure of a webpage is determined based on the type of fields a form contains. For example, this may be accomplished by maintaining a signature for different form types. One form may have multiple form signatures. One form may be part of another form. Form type analysis can then use the elements of the page and compare them with several signatures for each form type, determining the various forms present on a webpage.

In some aspects, the identification of a form type in turn allows for the identification of macro-actions/macroscopic actions that a user can take on that page or forms of the page. In one embodiment, form types contain a list of possible actions for that form type. The actions may be identified as “out” elements. In another embodiment, an additional algorithm that prevents the system from performing uncertain actions is additionally employed. For instance, if there are two buttons “goToCreateAccount” in one form, then it won't be considered as a possible action (because it is not possible to differentiate each button).

In one embodiment, a form type is associated with a set of conditions, that when met determine the type of form(s) present on a webpage. For example, a condition can be “there is at least one email input”, while another can be “there must be a maximum of 2 input text fields”. In one implementation, where an element of the DOM structure has all the conditions, then a form is created with the element as its parent. By doing so the element is “flagged” as being of that form type, meaning it meets the condition(s) of a form type. One element can meet conditions for more than one form type.

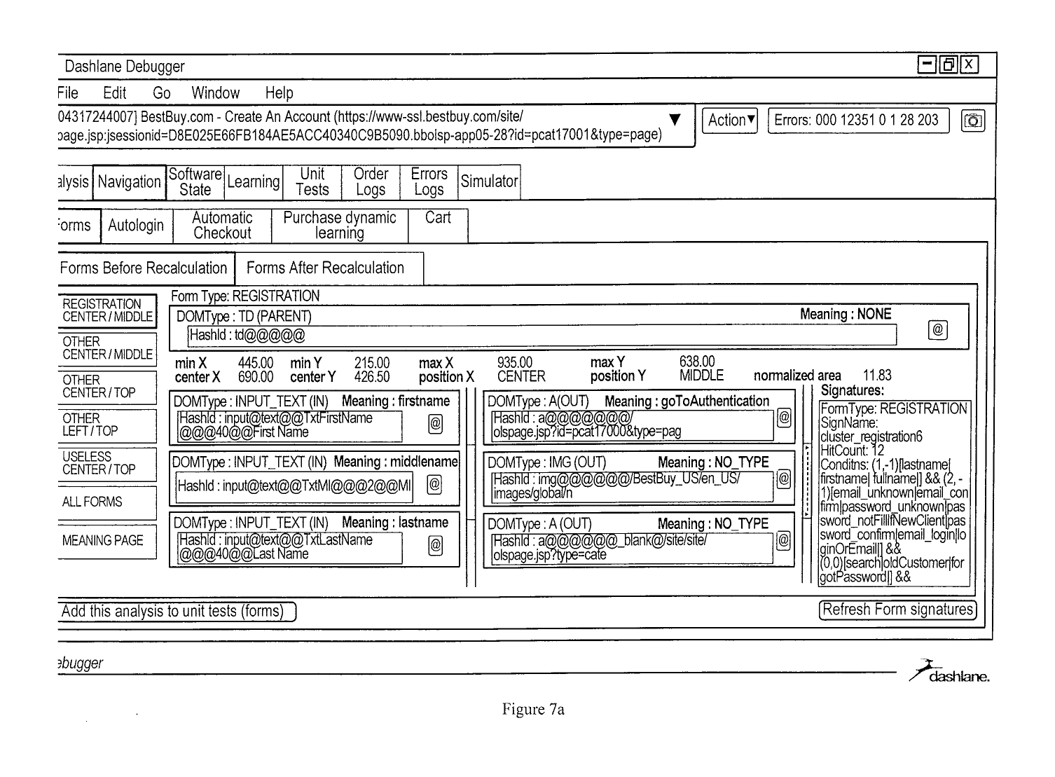

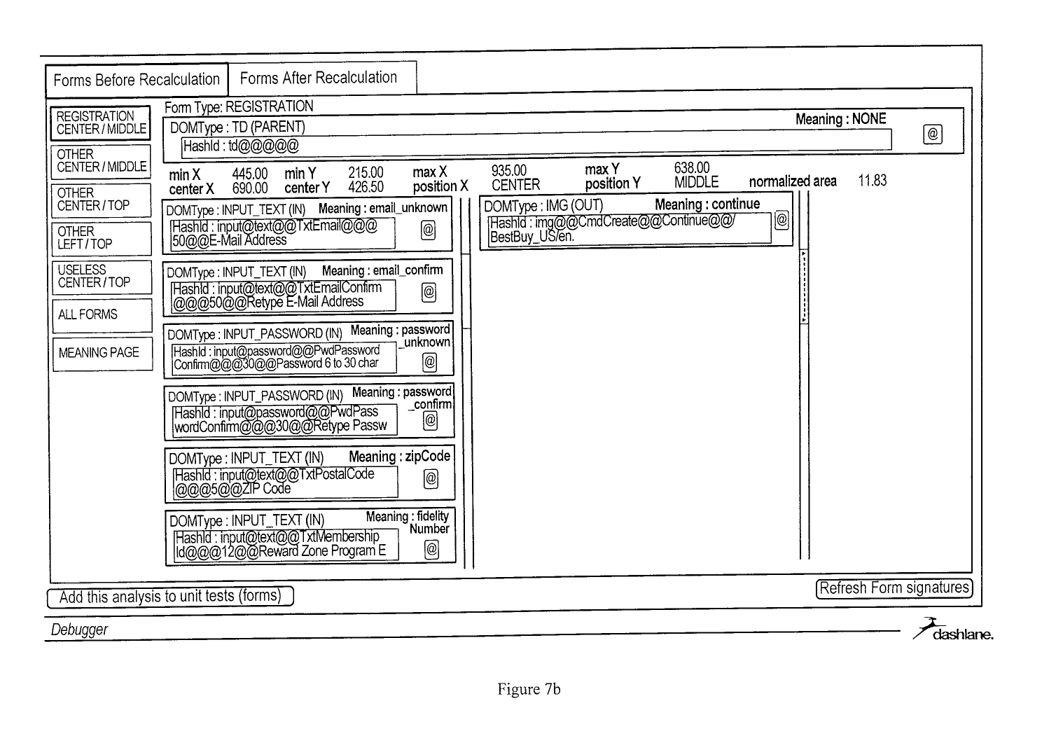

In one embodiment, a form signature can include “in” elements, “out” elements, and rules for ruling out false positives. “in” elements are those elements that can be filled in by a user (e.g., “input text” or “select” HTML form elements). “out” elements are those elements that lead to an action being taken that leads to another page being loaded (e.g., “button”, “link”, or an image with JavaScript event embedded in it) or those elements that lead to a significant change in the page (e.g., AJAX requests or dynamic JSP). In some aspects, the elements can have further details such as the number of elements of the type on a form. In one embodiment, the signature may specify other rules for avoiding false positives. A form can have more than one signature (e.g., a registration form—one website can ask on the first page an email, and on the second page the password and its confirmation, while another website can ask all those information together in one bigger form.). And one form can have another form in it (e.g., a registration form can contain in it a shipping form). FIG. 7 shows the results of evaluating a page against a registration form type.

FIG. 5 illustrates two form signatures. The login form contains the “in” elements “Email” and “Password”. Also, the signature specifies that the page must have one and only one of each one of these elements for it to constitute a login form type. The signature also specifies that a login form must have “out” elements “GoToAuthentication” and “Continue”. Furthermore, it identifies false positives for the login form type, that there mush be zero elements of search type, and that the form contains no more than two “in” elements and no more than one “out” element. Upon a page meeting this signature, it is identified as a login form.

In another example, FIG. 5 provides the signature for a billing address form. It requires an “in” element of text containing an indication of the string “billing address” and an “out” element of the type “ClickToEditAddress”. It also provides an additional rule that no element of the type “Shipping address” is in the form to avoid false positives.

### Rules Tool

FIG. 3 also depicts a rules tool 380. Tool 380 provides a user interface to manage rules. These rules provide the basis for the semantics analysis for the discovery engine 346. Advantageously, rules tool 380 allows for immediate verification or validation of a rule. In one embodiment, the validation is done by running the rule against previously stored web pages in real-time. Such immediate validation, then allows a user to modify or tweak a rule upon receiving the results of the validation. In one aspect, the results of the tools analysis can be shared across users.

In one embodiment, an atomic field-based rule can be defined. Such a rule for example might state that when a field contains a name “city”, then it is the city field of an address. In another embodiment, the rule can be constructed providing its context. For example, first, an element “city” can be found based on its atomic analysis. For instance that element can be found with the first analysis rules wherein “an element is an input text” and “the context of the element is exactly equals to city or town.”

Then considering the other elements, an address form can be defined (using form signatures). And to define that this address form is a billing address form, the analysis searches the entire element around the form to find any information about its nature (just as a human would do). For instance if the sentence “please enter your billing address” is present just before the form, then the form will be considered as a billing form.

In yet another embodiment, the rule can be defined specific to one or more domains. Such a rule will only be run against elements from a webpage of the specified domains. For example, a rule may be supplied for <vendor1>.com and <vendor2>.com. Then such a rule would only be run if the webpage being analyzed is either from <vendor1>'s or <vendor2>'s website.

The tool may also provide the user with some features to help in rule creation. For example, it may help a user decide what the context is for a rule. It may also help the rule administrator (e.g., most likely the administrator of the system described herein) with what parts of the code are useful for an element (e.g., the attribute tag or other HTML tags and their usage, or tooltip location in code, etc.). The tool may also help the user by providing rules that apply to an element and the associated score for those rules.

In some aspects, the rules tool can learn from past users actions. For instance, if on a page, a login form is identified, but the analysis could not identify on which button the user should click to be logged in, then the action that a user takes is recorded to replay it the next time the user wants to execute that form. Also, if several users do the same action on that website to be logged in, the information will be distributed to other users of the system described herein (i.e., so that the form recognition is complete).

### User Data Extraction, Storage, and Pre-Populating

In one embodiment, the discovery engine 346 of FIG. 3 also extracts data from fields or elements being analyzed or having been analyzed prior to the extraction. During or after the analysis, if user-supplied data is found then component 350 will extract and write such data to database 360. Such user-supplied data is stored with its associated context-based information to be later used to update or pre-populate fields on behalf of a user by the script generator 352. As illustrated in FIG. 4, in one embodiment these steps can be additionally performed during a webpage semantics analysis process. For example, during or after the analysis of the elements of a webpage the user-supplied data for each element can be extracted in step 430 and then stored to a local database in step 440. In one aspect, the analysis is done when a webpage is loaded, while the extraction of data takes place at the time that a webpage is unloaded (e.g., when a user navigates away from a page by taking another action such as “next”, “submit”, or clicking on link, etc.). Steps 430 and 440 are optional and may be executed by an analysis engine.

In one embodiment, the user interaction elements of a webpage, upon analysis are scored. And where the generated score is higher then a threshold score then the field is populated with context-based data that is stored for that particular element in the site-independent database 360. As illustrated in FIG. 4, this can be done in step 460 in one embodiment, thereby modifying the webpage with known data from the consumer database. In another embodiment, the populating of certain user interaction fields can be achieved by soliciting the user. The user may then input the required information. The user may also get some assistance from the system in populating the field. For example, the user may be provided a drop-down list to select data from, or an option to create a strong password on behalf of the user.

What is claimed is:

1. A computer-implemented method for determining webpage semantic structure, the method comprising:
detecting user interaction with a user-navigated webpage;
analyzing the user-navigated webpage using user-perception techniques; and
determining semantic structure of the user-navigated webpage based on the analysis, wherein the semantic structure provides information about the function of an element of the webpage, or forms on the webpage, or other information about the user-navigated webpage.

2. The method of claim 1, wherein the step of analyzing includes:
retrieving context-based rules; and
applying the context-based rules to the elements of the user-navigated webpage.

3. The method of claim 1, wherein the step of analyzing includes:
retrieving form signatures; and
applying them to the webpage to determine one or more form types.

4. The method of claim 3, further comprising determining possible macro-actions available based on the form type.

5. The method of claim 1, further comprising:
extracting user-supplied data from the user-navigated webpage during or after the analyzing; and
storing the extracted user-supplied data into a site-independent database.

6. The method of claim 1, further comprising:
modifying the user-navigated webpage by populating fields of the user-navigated webpage with available user information from a site-independent database, based on the determining of the semantic structure of the user-navigated webpage.

7. The method of claim 2, wherein in the step of applying the context-based rules, the elements are scored and populated with user data where the score is above a threshold score.

8. The method of claim 1, wherein storing occurs onto a local storage device, local to a client used by the user.

9. A computer-implemented method for real-time verification of a rule applied across multiple websites, the method comprising:
receiving a rule from a user;
retrieving saved pages of a plurality of websites;
applying the rule to the retrieved saved pages; and
validating the results of the applying of the rule in real-time.

10. The method of claim 9, further comprising:
presenting the results of the validation to the user upon validating; and
allowing the user to modify the rule based on the presenting of the validation results.

11. A method for analyzing a plurality of vendor web-based customer interfaces, wherein a web-based customer interface of a vendor comprises software and/or data, that when used with a browser or other client-side software, presents the web-based customer interface to a user, the method comprising:
analyzing a user-navigated web page of a target vendor web-based customer interface being analyzed, wherein the user-navigated web page contains interface elements designed for human interaction;
monitoring user inputs from a human user of the user-navigated web page's interface elements;
extracting user-supplied customer information from the user-navigated web page's interface;
matching the user-supplied customer information to context information about the user-navigated web page using results of the analyzing; and
storing the user-supplied customer information and corresponding context information with reference to the user-navigated web page and/or the target vendor web-based customer interface being analyzed, thereby allowing for the user-supplied customer information in different contexts for different vendor web-based customer interfaces.
